(19) United States
(12) Patent Application Publication
(10) Pub. No.: US 2026/0210731 A1
(43) Pub. Date: Jul. 23, 2026

(54) USE OF MACHINE VISION AND ML MODEL TO INTERPRET MAP DATA

(71) Applicant: DoorDash, Inc., San Francisco, CA (US)

(72) Inventors: Eric Pan, San Francisco, CA (US); Gayatri Iyengar, Cupertino, CA (US); Srinivasaraghavan Vedanarayanan, Sunnyvale,, CA (US)

(73) Assignee: DoorDash, Inc., San Francisco, CA (US)

(21) Appl. No.: 19/027,958

(22) Filed: Jan. 17, 2025

(51) Int. Cl. G01C 21/00; G06N 20/00; G06V 30/422

(52) U.S. Cl. CPC G01C 21/3811; G01C 21/3844; G06N 20/00; G06V 30/422

(57) ABSTRACT

A method includes a server computer obtaining location data and time data associated with a transporter user device of a transporter that travels from a first location to a second location during a journey. The server computer determines points along the journey using the location data and the time data. The server computer visually differentiates the points along the journey according to a predetermined criteria. The server computer creates a map showing the journey and the visually differentiated points. The server computer can input, into a machine learning model, the map showing the journey and the visually differentiated points to classify the journey.

### CROSS-REFERENCES

The present application is related to U.S. application Ser. No. ______ (Attorney Docket No. 107723-1460836), entitled “Efficient and Enhanced Map User Interface,” which is filed on the same day as the present application and is herein incorporated by reference in its entirety.

### SUMMARY

One embodiment is related to a method comprising: obtaining, by a server computer, location data and time data associated with a transporter user device of a transporter that travels from a first location to a second location during a journey; determining, by the server computer, points along the journey using the location data and the time data; visually differentiating, by the server computer, the points along the journey according to a predetermined criteria; creating, by the server computer, a map showing the journey and the visually differentiated points; and inputting, by the server computer into a machine learning model, the map showing the journey and the visually differentiated points to classify the journey.

Another embodiment is related to a server computer comprising: a processor; and a computer-readable medium coupled to the processor, the computer-readable medium comprising code executable by the processor for implementing a method comprising: obtaining location data and time data associated with a transporter user device of a transporter that travels from a first location to a second location during a journey; determining points along the journey using the location data and the time data; visually differentiating the points along the journey according to a predetermined criteria; creating a map showing the journey and the visually differentiated; and inputting, into a machine learning model, the map showing the journey and the visually differentiated points to classify the journey.

Another embodiment is related to a method comprising: obtaining, by a device, a journey identifier for a journey involving a transporter user device of a transporter that travels from a first location to a second location during the journey obtaining, by the device, a task identifier; providing, by a device, the journey identifier and the task identifier to a central server computer, wherein the central server computer obtains location data and time data associated with the transporter user device, determines points along the journey using the location data and the time data, visually differentiates the points along the journey according to a predetermined criteria, creates a map showing the journey and the visually differentiated points, and inputs, into a machine learning model, the map showing the journey and the visually differentiated points to classify the journey to form a classification; and receiving, by the device, the classification of the journey.

Further details regarding embodiments of the disclosure can be found in the Detailed Description and the Figures.

### BRIEF DESCRIPTION OF THE DRAWINGS

FIG. 1 shows a block diagram of a fulfilment system according to embodiments.

FIG. 2 shows a block diagram of components of a central server computer according to embodiments.

FIG. 3 shows a diagram illustrating a map showing a journey according to embodiments.

FIG. 4 shows a diagram illustrating a map showing visually differentiated information according to embodiments.

FIG. 5 shows a flow diagram of creating and analyzing a map according to embodiments.

FIG. 6 shows a diagram illustrating a map that is analyzed by a machine learning model according to embodiments.

FIG. 7 shows a flow diagram of a machine learning model training method according to embodiments.

### DETAILED DESCRIPTION

Prior to discussing embodiments of the disclosure, some terms can be described in further detail.

An “item” can be an individual article or unit. Examples of items can include perishable items such as food items, beauty items (e.g., cosmetics), office supply products (e.g., staples, paper, and ink), hardware items (e.g., nails, hammers, wrenches), electronic devices (e.g., computers, phones, etc.), jewelry, etc.

A “user” may include an individual or a computational device. In some embodiments, a user may be associated with one or more personal accounts and/or mobile devices. In some embodiments, the user may be a consumer or a customer.

A “user device” may be a device that is operated by a user. In some embodiments, the user device can be an electronic device that can process information and communicate with other electronic devices. A user device may include a processor and a computer-readable medium coupled to the processor, the computer-readable medium comprising code, executable by the processor. Examples of user devices may include a mobile device, a laptop or desktop computer, a wearable device, etc.

A “transporter” can be an entity that transports something. A transporter can be a person that transports an item using a transportation device (e.g., a car). In other embodiments, a transporter can be a transportation device that may or may not be operated by a human. Examples of transportation devices include cars, boats, scooters, bicycles, drones, airplanes, etc. In some embodiments, the user device can be integrated into a transportation device. A transporter can be an autonomous vehicle such as an autonomous car or autonomous drone.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a completed state, or a final state. A fulfillment request can include one or more selected items that a user wishes to obtain from a selected service provider.

A “delivery order” can include a request to deliver one or more items. Delivery orders can include requests to provide one or more items from a pickup location to a drop-off location. Delivery orders can include orders to deliver items from service provider locations to end user locations. Delivery orders can include orders to deliver items from end user locations to service provider locations. An example of this type of delivery order can be a return order (e.g., to deliver an item that is to be returned). A delivery order can include data to fulfill the delivery request including an order type, an indication of an item, a pickup location, and a drop-off location. In some embodiments, the delivery order can include a scheduling range by which the order is to be fulfilled. A delivery order can also include metadata. The metadata can include data relating to the delivery order (e.g., related order numbers, instruction data, etc.).

A “route” can include a way or course taken in getting from a starting point to a destination. For example, a route can indicate a path that can be followed to move from a pickup location to a drop-off location. In some embodiments, a route can indicate a suggested path that a transporter can follow to deliver an item from a service provider to an end user (or vice-versa) for a delivery order. A route can be a journey between two locations.

A “map” can include a diagrammatic representation of an area of land or sea showing physical features, cities, roads, and other information. In some embodiments, a map can display visuals indicating location data and time data, and can show a journey between two locations. For example, a map can show a journey of a transporter from a pickup location to a drop-off location to deliver an item to an end user. A map can also be interactive and can allow a user to interact with elements on the map.

“Location data” can include information that indicates a particular place or position. Location data can include information that indicates a location in space of an entity. For example, location data can indicate a location of a transporter user device. Location data can include a latitude and a longitude. In some embodiments, location data can include an altitude.

“Time data” can include information that indicates a particular point in time. Time data can include a time recorded with a UTC (coordinated universal time) time in GMT 0. Time data can include a time recorded in a local time in relation to a known location datum.

The term “artificial intelligence model” or “machine learning model” may refer to a model that may be used to predict outcomes to achieve a pre-defined goal. A machine learning model may be developed using a learning process, in which training data is classified based on known or inferred patterns.

“Machine learning” may refer to artificial intelligence processes in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or a recommendation (e.g., a movie that a user may like or a restaurant that a consumer might enjoy).

A “machine learning model” may refer to an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs. A machine learning model can be trained using “training data” (e.g., to identify patterns in the training data) and can apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

In the area of transportation, there is often a need to understand certain characteristics of journeys or behaviors of transporters on those journeys. For example, a first transporter may behave in a particular manner on a journey from a first location to a second location, while a second transporter may behave in a different manner when traveling from the first location to the second location. The first transporter may be behaving in a manner that indicates that they are intentionally delaying their journey while the second transporter may be behaving in a manner that indicates that they are not intentionally delaying their journey. Transportation entities such as food delivery services or ride-sharing services may monitor hundreds of thousands or millions of such journeys and may want to understand the characteristics those journeys or the behaviors of transporters on those journeys.

Machine learning models are used to make predictions. However, raw data associated with such journeys is stored in databases and needs to undergo significant preprocessing before the data is suitable to be training data for machine learning models. In addition, a voluminous amount of data is collected for the journeys monitored by entities such as ride-sharing entities or delivery services. Even before preprocessing the raw data, one needs to know where the data are stored and how to retrieve the data.

All of this requires a significant amount of effort and computational resources.

Embodiments of the disclosure address these problems and other problems individually and collectively.

Embodiments of the disclosure allow for map generation using journey data and evaluation of the maps using machine learning models. A computer can generate a map using journey data, which can include location data and time data associated with a journey. The computer can determine a visualization preset for a task that is to be performed using the machine learning model. The task can be identified by a task identifier. The computer can visually differentiate map elements using the visualization preset. Each machine learning task can correspond to a different visualization preset. The computer can use the map and the machine learning model to classify the journey. For example, the computer can perform a task of determining whether or not a transporter involved in the journey intentionally delayed the journey. The determined classification for the journey can be “intentional delay” or “no intentional delay.”

By training machine learning model with the maps with transporter journeys, the machine learning model is trained more quicky and with less data than using raw data. The training data used to train the machine learning model can be obtained from a single database of map data. Further, since maps are visual, the use of maps as training data for a machine learning model and as test data to request predictions is more intuitive to human users.

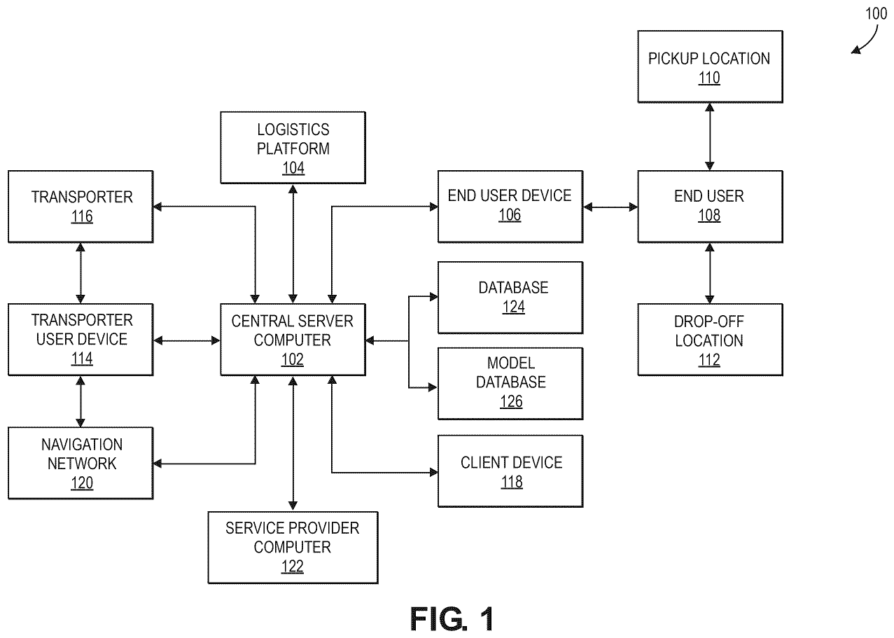

FIG. 1 shows a system 100 according to embodiments of the disclosure. The system of FIG. 1 includes a central server computer 102, a logistics platform 104, an end user device 106, an end user 108, a pickup location 110, a drop-off location 112, a transporter user device 114, a transporter 116, a client device 118, a navigation network 120, a service provider computer 122, a database 124, and a model database 126.

The central server computer 102 can be in operative communication with the logistics platform 104, the end user device 106, the transporter user device 114, the client device 118, the navigation network 120, the service provider computer 122, the database 124, and the model database 126. The transporter user device 114 can be in operative communication with the navigation network 120.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. For example, although FIG. 1 shows one transporter 116, there can be two, three, or more transporters, transporter user devices, etc.

Messages between the devices and the computers in the system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 102 can include a server computer that can facilitate in the fulfillment of fulfillment requests received from the end user device 106. For example, the central server computer 102 can identify the transporter 116 (from among many candidate transporters) operating the transporter user device 114 as being suitable for satisfying the fulfillment request. The central server computer 102 can identify the transporter user device 114 that can satisfy the fulfillment request based on any suitable criteria (e.g., transporter location, service provider location, end user destination, end user location, transporter mode of transportation, etc.).

The central server computer 102 can receive data relating to a delivery order of items from the service provider computer 122 to the end user 108 at the drop-off location 112. The central server computer 102 can determine a route for delivery of the delivery order. The central server computer 102 can present the routes to a plurality of transporter user devices and/or transporters. The central server computer 102 can receive acceptances from the transporter 116 that will deliver the items from the pickup location 110 to the drop-off location 112.

The central server computer 102 can receive data from the transporter user device 114. The central server computer 102 can receive location data and time data associated with the transporter user device 114 of the transporter 116 that travels from a first location (e.g., the pickup location 110) to a second location (e.g., the drop-off location 112) during a journey. The central server computer 102 can store the location data and the time data in the database 124.

The central server computer 102 can create a map showing the journey, which displays visually differentiated points along the journey. The central server computer 102 can classify the journey, or determine other information related to the journey, using a machine learning model. The machine learning model can be trained to evaluate images. The machine learning model can include, for example, a convolutional neural network.

The logistics platform 104 can include a location determination system, which can determine the locations of various user devices such as transporter user devices (e.g., the transporter user device 114) and end user devices (e.g., the end user device 106). The logistics platform 104 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 104 can be part of the central server computer 102 or can be a system that is separate from the central server computer 102.

The end user device 106 can include a device operated by the end user 108. The end user devices 106 can generate and provide fulfillment request messages to the central server computer 102. The fulfillment request message can indicate that the request (e.g., a request for a service) can be fulfilled by the service provider computer 122. For example, the fulfillment request message can be generated based on a cart selected at checkout during a transaction using a central server computer application installed on the end user device 106. The fulfillment request message can include one or more items from the selected cart.

The end user device 106 can provide a fulfillment request message to the central server computer 102 that indicates that the end user device 106 is requesting that the transporter 116 pick up an item from the pickup location 110 (e.g., end user's 108 location) and deliver the item to the drop-off location 112 (e.g., the service provider computer's 122 location).

The pickup location 110 can be a location in which items are stored. In the context of an outbound delivery from an end user at an end user location, examples of the pickup location 110 may be a house or an apartment, a mailbox, a service provider location (e.g., a retail store, a grocery store, a dry cleaning store), a pickup hub, etc. Items can first be obtained from a pickup location 110 and then be transported to the drop-off location 112. Examples of the drop-off location 112 can be similar to the pickup location 110, such as a house or apartment, a mailbox, a retail store, a grocery store, a dry cleaning store, a pickup hub, etc. In one example, the pickup location 110 can be a pizza parlor from which the end user 108 orders a pizza. The drop-off location 112 can be an apartment in which the end user 108 resides.

The transporter user device 114 can include a device operated by the transporter 116. The transporter user device 114 can include a smartphone, a wearable device, a personal assistant device, etc. The transporter 116 can accept an end user's fulfillment request via an acceptance message. For example, the transporter user device 114 can generate and transmit a request to fulfill a particular end user's fulfillment request to the central server computer 102. The central server computer 102 can notify the transporter user device 114 of the fulfillment request. The transporter user device 114 can respond to the central server computer 102 with a request to perform the delivery to the end user as indicated by the fulfillment request.

In some embodiments, the transporter 116 can be an operator of a vehicle. In other embodiments, the transporter 116 can be a vehicle that can be operated by an operator or can be autonomous. The vehicle can include a car, a truck, a van, a motorcycle, a bicycle, a drone, or other vehicle. If the vehicle is autonomous, it can be routed automatically by the central server computer 102 according to one or more determined routes.

The client device 118 can provide information to or request information from the central server computer 102. In some embodiments, the client device 118 can be operated by a user that requests information from the central server computer 102 related to a journey. In some embodiments, the client device 118 can be the transporter user device 114. In other embodiments, the client device 118 can be the end user device 106. The client device 118 can provide a journey classification request to classify a journey to the central server computer 102. The client device 118 can receive the classification of the journey from the central server computer 102.

The navigation network 120 can provide navigational directions to the transporter user device 114. For example, the transporter user device 114 can obtain a location from the central server computer 102. The location can be a service provider parking location, a service provider location, an end user parking location, an end user location, etc. The navigation network 120 can provide navigational data to the location to the transporter user device 114. For example, the navigation network 120 can include a global positioning system that provides location data to the transporter user device 114.

The service provider computer 122 can be operated by a service provider. For example, the service provider computer 122 can be operated by a service provider such as a restaurant. The service provider can provide services to the end user 108 of the end user device 106. In embodiments of the invention, the service provider computer 122 can receive requests to prepare one or more items for delivery from the central server computer 102. The service provider computer 122 can initiate the preparation of the one or more items that are to be delivered to the end user 108 of the end user device 106 by the transporter 116 associated with the transporter user device 114.

The database 124 can include any suitable database. The database may be a conventional, fault tolerant, relational, scalable, secure database such as those commercially available from Oracle™ or Sybase™. The database 124 can store location data (e.g., a location that includes a latitude and longitude, etc.) and time data (e.g., a specific time).

The model database 126 can similarly be a conventional, fault tolerant, relational, scalable, secure database. The model database 126 can store machine learning models. The model database 126 can store a plurality of machine learning models where each machine learning model is stored in association with a task identifier that identifies the task that the machine learning model performs.

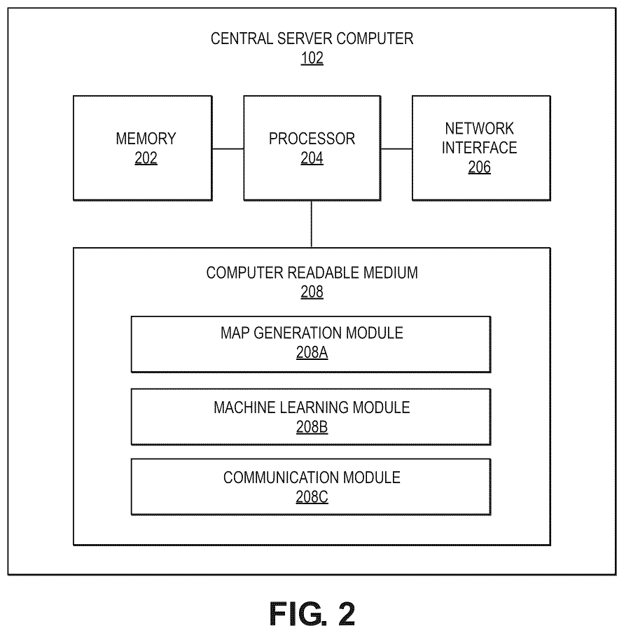

FIG. 2 shows a block diagram of an exemplary central server computer 102 according to embodiments. The central server computer 102 may comprise a processor 204. The processor 204 may be coupled to a memory 202, a network interface 206, and a computer readable medium 208. The computer readable medium 208 can comprise a map generation module 208A, a machine learning module 208B, and a communication module 208C.

The memory 202 can be used to store data and code. For example, the memory 202 can store map data, location data, time data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: obtaining location data and time data associated with a transporter user device of a transporter that travels from a first location to a second location during a journey; determining points along the journey using the location data and the time data; visually differentiating the points along the journey according to a predetermined criteria; creating a map showing the journey and the visually differentiated points; and inputting, into a machine learning model, the map showing the journey and the visually differentiated points to classify the journey.

The map generation module 208A may comprise code or software, executable by the processor 204, for generating maps. The map generation module 208A, in conjunction with the processor 204, can receive a request to generate a map showing a journey. The request can include a journey identifier that identifies the journey. The map generation module 208A, in conjunction with the processor 204, can generate the map using location data, time data, and any other map information obtained from a database using the journey identifier. The map generation module 208A, in conjunction with the processor 204, can generate the map using data from the database 124. The map generation module 208A, in conjunction with the processor 204, can generate any number of maps for evaluation by the machine learning module 208B. For example, the map generation module 208A, in conjunction with the processor 204, can generate 500, 1,000, 4,000, 10,000, 100,000, 1,000,000, or more maps.

The map generation module 208A, in conjunction with the processor 204, can obtain pre-generated satellite imagery and/or road network images. The pre-generated satellite imagery and/or road network images can be a background of what a user will see when looking at the map. Each location on the images of the pre-generated satellite imagery and/or road network images can correspond with a location (e.g., a GPS location). The map generation module 208A, in conjunction with the processor 204, can overlay location data on the map over the pre-generated satellite imagery and/or road network images.

The map generation module 208A, in conjunction with the processor 204, can also place other map elements on the map, such as geofences. For example, a geofence can be identified by a location at a radius (if the geofence is circular). The map generation module 208A, in conjunction with the processor 204, can draw a perimeter of a circle on the map at the location of the geofence with the defined radius.

The map generation module 208A, in conjunction with the processor 204, can place each element on the map using different colors, shapes, patterns, etc. to indicate further information related to the element. For example, the map generation module 208A, in conjunction with the processor 204, can place transporter location data on the map using circles, where the color and/or size of the circle indicates the speed of the transporter. The map generation module 208A, in conjunction with the processor 204, can draw the geofences on the map with different colors based on the meaning of the geofences.

The machine learning module 208B may comprise code or software, executable by the processor 204, for training, utilizing, and maintaining machine learning models. The machine learning module 208B, in conjunction with the processor 204, can train and utilize a plurality of machine learning models. Each machine learning model of the plurality of machine learning models can be identified with a task identifier. The machine learning module 208B, in conjunction with the processor 204, can select a machine learning model using the task identifier from the model database 126.

The machine learning module 208B, in conjunction with the processor 204, can input a map (e.g., created by the map generation module 208A) showing a journey and visually differentiated points into the selected machine learning model to classify the journey. The machine learning model can be a deep learning neural network or a convolutional neural network. The machine learning module 208B, in conjunction with the processor 204, can be trained using 500, 1,000, 4,000, 10,000, 10,0000, 1,000,000, or more maps that are generated by the map generation module 208A.

In embodiments of the invention, the machine learning model can perform a task related to the input image. The machine learning model can perform image classification, object detection, segmentation, content-based image retrieval, etc. As an example task, a machine learning model can accept an image as input and determine a classification of whether or not a journey depicted on a map in the image is a successful delivery by an autonomous vehicle or an unsuccessful delivery by the autonomous vehicle.

The communication module 208C may comprise code or software, executable by the processor 204, for communicating with other devices. The communication module 208C may be configured or programmed to perform some or all of the functionality associated with receiving, sending, and generating electronic messages for transmission through the central server computer 102 to or from any of the devices illustrated in FIG. 1. When an electronic message is received by the central server computer 102 via the network interface 206, the message can be passed to the communication module 208C. The communication module 208C, in conjunction with the processor 204, can identify and parse the relevant data based on a particular messaging protocol used in the central server computer 102. As an example, the received information may comprise identification information, authorization information, request information, response information, and/or any other information that the central server computer 102 may utilize in processing a message or a response. The communication module 208C, in conjunction with the processor 204, may then provide any received information to an appropriate module within the central server computer 102. The communication module 208C, in conjunction with the processor 204, may also receive information from one or more of the modules in the central server computer 102 and generate an electronic message in an appropriate data format in conformance with a transmission protocol used in another device so that the message may be sent to one or more devices within system 100. The electronic message can then be passed to the network interface 206 for transmission.

The network interface 206 may include an interface that can allow the central server computer 102 to communicate with external computers. The network interface 206 may enable the central server computer 102 to communicate data to and from another device (e.g., the logistics platform 104, the end user device 106, the transporter user device 114, the client device 118, the service provider computer 122, the database 124, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

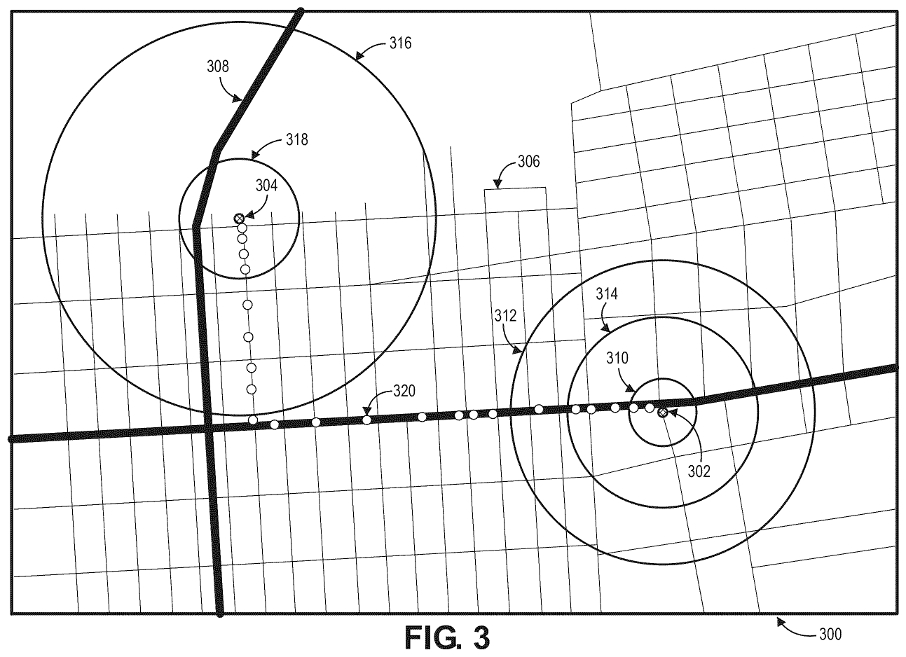

FIG. 3 shows a diagram illustrating a map 300 showing a journey according to embodiments. The diagram illustrated in FIG. 3 will be described in the context of a transporter (e.g., a person) that is operating a transporter user device (e.g., a mobile phone). In some cases, the transporter can be an autonomous vehicle and the transporter user device can be a component in the autonomous vehicle. The transporter picks up one or more items from a pickup location 302 to deliver to a drop-off location 304 for a journey that includes a delivery. The central server computer 102 can generate the map 300 for evaluation of the map by a machine learning model.

The map 300 includes the pickup location 302 and the drop-off location 304. The pickup location 302 and the drop-off location 304 can be identified by symbols on the map 300 (e.g., circles filled with hatching). The pickup location 302 can be a merchant pick up location where the transporter can obtain the one or more items that are to be provided to the end user. The drop-off location 304 can be an end user drop-off location, such as a home address, a work address, or a current location of the end user.

The map 300 also includes a plurality of roads, which are indicated by lines. The map 300 includes symbols that indicate two categories of road. The map 300 includes small roads 306 and large roads 308 where the thickness of the line indicates that category of the road.

The map 300 includes concentric circles around the pickup location 302 and the drop-off location 304. The concentric circles can be geofences that indicate a boundary in the physical space represented by the map 300. The map 300 can include a first pickup location geofence 310, a second pickup location geofence 312, and a third pickup location geofence 314. The map 300 can also include a first drop-off location geofence 316 and a second drop-off location geofence 318. Each geofence can indicate boundary with a different meaning.

For example, the first pickup location geofence 310 can be an approaching merchant geofence that indicates that the transporter is approaching the pickup location 302 of the merchant when proceeding to the pickup location 302. When the transporter crosses the boundary of the first pickup location geofence 310, the central server computer 102 can notify the transporter user device and the end user device that the transporter is near the merchant location.

The second pickup location geofence 312 can be a wide approaching merchant geofence that indicates that the transporter is generally approaching the pickup location 302 of the merchant when proceeding to the pickup location 302. The second pickup location geofence 312 can have a larger distance (e.g., radius) from the pickup location 302 than the first pickup location geofence 310. The second pickup location geofence 312 can provide for an initial indication that the transporter is approaching the pickup location 302.

The third pickup location geofence 314 can be a leaving merchant geofence that indicates that the transporter is leaving the pickup location 302 of the merchant after having been at the pickup location 302. When the transporter crosses the boundary of the third pickup location geofence 314, the central server computer 102 can notify the transporter user device and the end user device that the transporter is leaving the merchant location with the one or more items for delivery.

The first drop-off location geofence 316 can be a wide approaching the drop-off location geofence that indicates that the transporter is generally approaching the drop-off location 304. When the transporter crosses the boundary of the first drop-off location geofence 316, the central server computer 102 can notify the transporter user device and the end user device that the transporter is near the end user drop off location.

The second drop-off location geofence 318 can be an approaching drop-off geofence that indicates that the transporter is approaching the drop-off location 304 of the merchant when proceeding to the drop-off location 304. The second drop-off location geofence 318 can have a smaller distance (e.g., radius) from the drop-off location 304 than the first drop-off location geofence 316. The second drop-off location geofence 318 can provide for a fine grained indication that the transporter is near to the drop-off location 304.

The map 300 also includes a plurality of location data, which are indicated by circles. The plurality of location data can include an exemplary location data 320. Each location data of the plurality of location data can indicate a point in space at which the position of the transporter and/or the transporter user device was recorded and provided to the central server computer. Each location data can correspond to a time data that indicates a point in time at which the location data was recorded. The plurality of location data can indicate a path on the map 300 that the transporter proceeded along to complete the journey.

For example, to obtain the location data, coordinates and an atomic time can be obtained by a terrestrial global positioning system (GPS) receiver in the transporter user device from GPS satellites orbiting the Earth. The GPS receiver can collect data from at least four GPS satellites orbiting the Earth in order to calculate a position in three dimensions. The GPS coordinates can be exact points of latitudinal and longitudinal direction determined from GPS satellites.

In some embodiments, when the transporter and/or the transporter user device records the location data, additional data can be recorded (e.g., speed, time, mode of transportation, traffic conditions, status updates, etc.). The location data, when displayed on the map 300, can be modified by the additional data. For example, the location data 320 can be colored based on the speed of the transporter. As another example, the location data 320 can be drawn on the map 300 with a different shape depending on the mode of transportation of the transporter (e.g., circle for cars, square for drones, etc.).

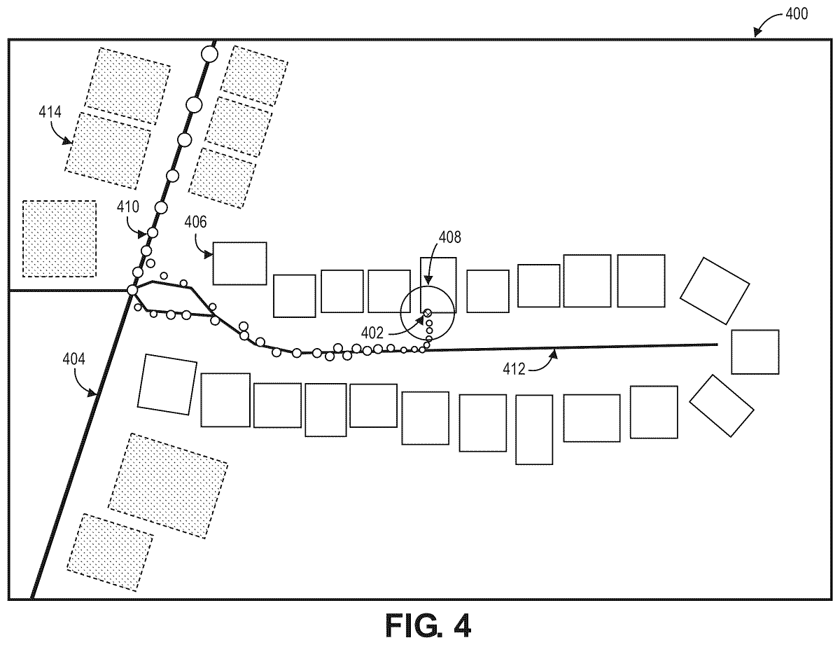

FIG. 4 shows a diagram illustrating a map 400 showing visually differentiated information according to embodiments. The diagram illustrated in FIG. 4 will be described in the context of a transporter that is a transporter user that operates a transporter vehicle (e.g., a car) and operates a transporter user device (e.g., a smartphone). The transporter picks up one or more items from a pickup location (not shown) to deliver to a drop-off location 402 for a journey that includes a delivery. The central server computer 102 can generate the map 400.

The map 400 includes the drop-off location 402. The drop-off location 402 can be identified by a symbol on the map 400 (e.g., a circles with hatching). The drop-off location 402 can be an end user drop-off location, such as a home address of the end user.

The map 400 also includes a plurality of roads, which are indicated by lines. As an example, the map 400 includes a first road 404 and a second road 412. The first road 404 can be visually distinct from the second road 412 to illustrate their different relative sizes, rules, or characteristics. For example, the central server computer 102 can generate the lines that indicate the roads based on information related to the road. For example, the first road 404 can be a larger road with a higher speed limit than the second road 412. The first road 404 can be displayed with a larger line weight than the second road 412. In this example, the line weights used to display the roads can correspond to the speed limits of the roads.

The map 400 includes a plurality of structures including a first structure 406 and a second structure 414. The structures can be indicated by rectangles on the map 400. The structures can include buildings. The first structure 406 can be a residential building (e.g., a house, an apartment, etc.). The second structure 414 can be a commercial building (e.g., a store, an office, etc.).

Residential buildings and commercial buildings can be visually distinct from one another. For example, the first structure 406, and other residential buildings, can be visualized using a solid border line and a solid white fill. The second structure 414, and other commercial buildings, can be visualized using a dotted border line and a dotted fill pattern.

The map 400 includes a drop-off location geofence 408 around the drop-off location 402. The drop-off location geofence 408 can be a geofence that indicates a boundary in a physical space represented by the map 400. The drop-off location geofence 408 can be an approaching end user drop-off location geofence that indicates that the transporter is approaching the drop-off location 402 of the end user when proceeding to the drop-off location 402. When the transporter crosses the boundary of the drop-off location geofence 408, the central server computer 102 can notify the transporter user device and/or the end user device that the transporter is near the merchant location.

The map 400 also includes a plurality of location data, which are indicated by circles. The plurality of location data can include an exemplary location data 410. Each location data of the plurality of location data can indicate a point in space at which the position of the transporter and/or the transporter user device was recorded and provided to the central server computer. Each location data can correspond to a time data that indicates a point in time at which the location data was recorded. The plurality of location data can indicate a path on the map 400 that the transporter proceeded along to complete the journey as well as the path before and after the journey.

The plurality of location data can be visually differentiated from the drop-off location 402 by the pattern hatching included in the circle used to display the points on the map 400. For example, the plurality of location data have no pattern, whereas the drop-off location 402 includes a hatch pattern.

Furthermore, the location data can be visually distinct from the roads and the structures. The location data, the roads, and the structures can be displayed using different shapes than one another. For example, the location data can be displayed using circles, the roads can be displayed using lines, the structures can be displayed using rectangles.

Each location data point created on the map 400 (e.g., by the central server computer 102) can be sized based on the speed of the transporter at the location. For example, larger circles, representing the location data points, can be indicate a higher speed, whereas smaller circles can indicate a lower speed. As such, the transporter speed can be visualized on the map 400 based on the visually distinct location data point sizes. It is understood that other graphical properties can be used to indicate speed other than data point size. For example, the color of the location data points can be colored on a gradient to indicate speed (e.g., the color green indicating fast and the color red indicating slow).

As an illustrative example, when the transporter user device crosses the drop-off location geofence 408, the central server computer can notify the transporter user device of the proximity of the drop-off location 402. The central server computer can also prompt the end user device to capture the image of the items when the items are delivered to the drop-off location 402. The end user device can transmit supplemental information including an image of the delivered items to the central server computer.

In some embodiments, different layers can be used to visualize the map 400. Each layer can visualize different data for the journey. For example, a first layer can visualize transporter location. A second layer can visualize structures and roads.

In some cases there can be different layer types for one dataset topic (e.g., transporter journey). From one dataset, the central server computer 102 can create different formats that are optimized for different layer types and visualizations. For example, the transporter location data and time data can be used to create two layers: 1) a point layer and 2) an animated trip layer. The point layer can illustrate instantaneous information at each point (e.g., displaying a speed, a status, a GPS accuracy, etc.), whereas the animated trip layer can display a moving line that shows relative speed and dwell time.

The central server computer 102 can also split one type of data into multiple layers. For example, the central server computer 102 can extract data from the delivery data to create a service provider and end user locations layer for pickup and drop-off and then extract a list of delivery events to put into a separate layer. As such, from the delivery data, the central server computer 102 can generate two layers. Doing so allows for different fields in a single dataset to be separated to focus on separate facets of the facts and information available.

The map 400 can be created using a visualization preset. A visualization preset can indicate what types of data to including on the map 400 and how to visually differentiated the data. The central server computer 102 can utilize custom visualization configurations for specific tasks (e.g., machine learning classification tasks). For example, to determine if a transporter is fraudulently claiming that they delivered an item to an end user, the central server computer 102 can generate the map 400 to show the path of the delivery of the item to the end user and can then decide if the transporter actually completed the delivery of the item. The visualization preset can optimize the generated map 400 for input into the machine learning model to evaluate the task.

As an illustrative example, a credits and refunds fraud task can include a visualization present that includes the following steps. The central server computer 102 can center the map 400 on the drop-off location 402. The central server computer 102 can then zoom into a predetermined zoom level (e.g., show a distance of X meters of scale from edge to edge of the map). The central server computer 102 can then set a basemap to display satellite imagery. The central server computer 102 can then use a 1 meter radius for transporter location data (e.g., GPS points). The central server computer 102 can color the location data points by speed (e.g., based on predetermined speed ranges for stationary, walking, running/slow driving, anything faster). The central server computer 102 can then label relevant events on the map (e.g., a location at which the transporter enters the drop-off location geofence 408). These presets can be set by an analyst in advance of the generation of the map.

As another illustrative example, a time abuse task can include a visualization present that includes the following steps. The central server computer 102 can orient the zoom and scale of the map 400 to display the entire delivery (e.g., display every location of the transporter during the delivery). The central server computer 102 can set a basemap to display stoplights and streets. The central server computer 102 can then color the location data points to be red where the transporter's speed is less than a predetermine threshold (e.g., 15 miles per hour) and green elsewhere.

In some embodiments, the central server computer 102 can utilize default labels to display events on the map 400. In some embodiments, the central server computer 102 can label locations associated with key delivery milestones such as a location at which the delivery was assigned, a location at which the deliver was confirmed, a pickup location, a drop location, a delivery verification photo location, etc. Rather than labeling everything by default and making the map illegible or labeling nothing, the central server computer 102 can define a subset of key events to label, allowing a machine learning model to grasp the situation of a delivery.

The central server computer 102 can utilize a consistent color palette when generating the map 400. When multiple elements in a map might appear to be the same, the central server computer 102 can use a consistent color palette scheme and pairing to visually differentiate the elements if they are in fact different. For example, when there are multiple transporters that were involved in the same delivery, the color of the location data for each transporter can be consistent based on the order of involvement of the transporter. The order of involvement of the transporter can be indicate by a transporter index. For example, a first involved transporter can have a transporter index of 0 and can be colored as red, a second involved transporter can have a transporter index of 1 and can be colored as yellow, and a third involved transporter can have a transporter index of 2 and can be colored as green. As another example, transporters that are users traveling by bicycles can be indicated as squares, transporters that are users traveling by cars can be indicated as circles, transporters that are autonomous cars can be indicated as triangles, and transporters that are autonomous drones can be indicated as hexagons. As another example, when showing geofences around pickup locations and drop-off locations, the central server computer 102 can display geofences around the pickup locations as blue and display geofences around drop-off locations as brown.

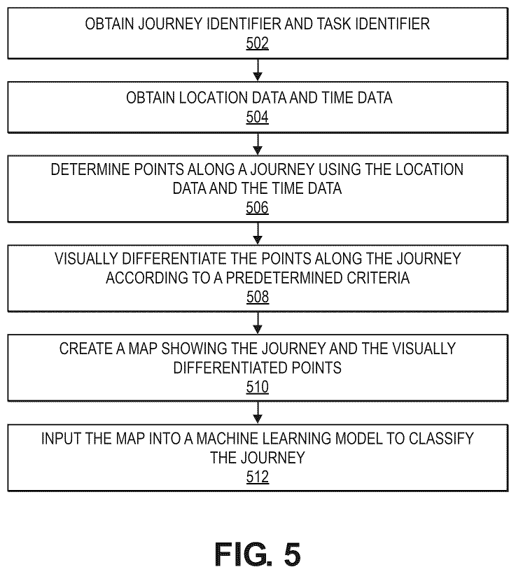

FIG. 5 shows a flow diagram of creating and analyzing a map according to embodiments. The method illustrated in FIG. 5 will be described in the context of the central server computer 102 generating a map for a journey and using a machine learning model to classify the journey. Prior to step 502, data associated with many journeys by many transporters can be collected and stored in a database by the central server computer 102.

At step 502, the central server computer 102 can obtain a journey identifier and a task identifier associated with a journey. The journey identifier can identify a journey and can be an alphanumeric value.

The task identifier can identify a particular machine learning task. For example, the task identifier can identify an intentional delay determination task (e.g., to determine whether or not a transporter intentionally delayed the journey), a fraud determination task (e.g., to classify an image of the map as fraudulent or not fraudulent to indicate if fraud occurred during the journey), or other machine learning task.

In some embodiments, the central server computer 102 can obtain the journey identifier and the task identifier from a client device (e.g., the client device 118). For example, the client device 118 may be operated by a user (e.g., an analyst) that is requesting the central server computer 102 to determine whether or not the transporter associated with the journey indicated by the journey identifier intentionally delayed delivery of an item to an end user.

In other embodiments, the central server computer 102 can periodically and automatically evaluate journeys for particular tasks. For example, the central server computer 102 can evaluate each journey, every other journey, etc. using the intentional delay determination task. In some embodiments, the central server computer 102 can evaluate journeys associated with certain items, amounts, distances, or other journey parameters.

At step 504, after obtaining the journey identifier and the task identifier, the central server computer 102 can obtain location data and time data associated with the journey. The central server computer 102 can obtain the location data and the time data, and any other suitable data (e.g., journey event data), from a database (e.g., the database 124) using the journey identifier.

At step 506, the central server computer 102 can determine points along the journey using the location data and the time data. The points can be map elements that are to be placed on a map. The central server computer 102 can determine the points based on the location data, the time data, and other journey data related to the location and/or time (e.g., speed data).

At step 508, the central server computer 102 can visually differentiate the points along the journey according to predetermined criteria. The central server computer 102 can visually differentiate the points using a visualization preset determined by the user. The central server computer 102 can determine graphical properties of the points or features on the map, as described above.

In some embodiments, the central server computer 102 can obtain a visualization preset from a database that is associated with the task identifier. Each task can correspond to a different visualization preset. The visualization preset can include instructions on how to visualize map elements to optimize the related machine learning task.

As an illustration, the central server computer 102 can generate a visualization preset request message comprising the task identifier. The central server computer 102 can provide the visualization preset request message to a database. The central server computer 102 can receive a visualization preset response message comprising visualization preset related to the task identifier.

Using the visualization preset, the central server computer 102 can determine a shape, a size, a color, a border type, etc. For example, the central server computer 102 can generate a point on a map according to the following:

```
{
  location: (37.774929, −122.419418),
  time: 2024-10-10T19:20:30+01:00,
  speed: 37 mph,
  shape: circle,
  color: yellow,
  size: 5,
  border: solid
}
```

At step 510, after determining the visually differentiated points along the journey, the central server computer 102 can create a map showing the journey and the visually differentiated points. The central server computer 102 can generate the map by using data obtained from the database 124. The central server computer 102 can obtain pre-generated satellite imagery and/or road network images that relate to the locations identified in the location data. The pre-generated satellite imagery and/or road network images can span an area that can encompass all location data points. The pre-generated satellite imagery and/or road network images can be a background of what a user will see when looking at the map.

At step 512, after generating the map, the central server computer 102 can input the map into a machine learning model to classify the journey. The central server computer 102 can obtain the machine learning model from a model database (e.g., the model database 126) using the task identifier. The model database 126 can store a plurality of machine learning models where each machine learning model is stored in association with a task identifier that identifies the task that the machine learning model performs.

The central server computer 102 can generate a model request message comprising the task identifier. The central server computer 102 can provide the model request message to the model database 126. After receiving the model request message, the model database 126 can retrieve the machine learning model that corresponds to the task identifier. The model database 126 can generate a model response message comprising the machine learning model. The model database 126 can provide the model response message to the central server computer 102.

After obtaining the machine learning model, the central server computer 102 can generate an image from the map. The image can be a snapshot of the map. The central server computer 102 can generate the image so that the map is in a format that can be input into the machine learning model.

In some embodiments, the central server computer 102 can perform pre-processing methods on the image prior to inputting the image into the machine learning model. For example, the central server computer 102 can perform contrast enhancement to ensure that relevant information can be more easily detected. As another example, the central server computer can resize the image to a uniform size such that the size of the image corresponds to the input size used by the machine learning model. Additional image processing methods include grayscaling (e.g., to simplify the image data and reduce computation needs for some algorithms), normalization (e.g., to adjust the intensity of each pixel to a value between 0 and 1), binarization (e.g., to threshold the image to black and white), applying a Gaussian blur (e.g., to smooth edges and details), applying a Laplacian filter (e.g., to detect edges), etc.

The central server computer 102 can input the image into the machine learning model to perform the task indicated by the task identifier. For example, the machine learning model can perform an intentional delay determination task to classify whether or not a transporter intentional delayed delivering an item to an end user during the journey.

The machine learning model can include any machine learning model capable of accepting images, or numbers derived from the images, as input. For example, the machine learning model can be a deep learning neural network or a convolution neural network.

A deep learning neural network can be a type of machine learning model that uses neural networks. Deep learning neural networks are made of many layers of artificial neurons that use mathematical calculations to automatically process different aspects of image data and gradually develop a combined understanding of the image.

Convolutional neural networks (CNNs) utilize a labeling system to categorize visual data and comprehend an image as a whole. Convolutional neural networks analyze images as pixels and give each pixel a label value. The value is evaluated using a mathematical operation called a convolution and can be used to make predictions about the image. A convolutional neural network can first identify outlines and simple shapes before filling in additional details like color, internal forms, and texture. The convolution neural network can repeat the prediction process over several iterations to improve accuracy.

The central server computer 102 can determine an output from the machine learning model based on the input derived from the map. The central server computer 102 can determine an output classification that indicates, for example, whether or not the transporter intentionally delayed delivering an item to an end user.

As another example, the output classification can be a classification of whether or not the transporter involved in the journey actually delivered an item for the journey at a drop-off location. As yet another example, the output classification can be a classification of whether or not a transporter that is an autonomous vehicle successfully navigated the journey.

After determining the classification using the machine learning model, the central server computer 102 can perform further processing based on the classification. For example, if the journey identifier and the task identifier were received from the client device 118 at step 502, further processing can include the central server computer 102 can providing the classification to the client device 118. Further processing can also include storing the classification into the database 124 in association with the journey identifier. In some other embodiments, further processing can include the central server computer 102 generating a notification related to the classification and sending the notification to another device (e.g., a client device, a transporter device, an end user device, etc.).

In other embodiments, further processing can include the central server computer 102 determining whether or not a predetermined number (e.g., 3, 5, etc.) of previous journey classifications associated with the transporter of the current journey are classified as intentional delay. If the transporter is associated with the predetermined number intentional delay classifications, then the central server computer 102 can provide a notification of the intentional delay classifications to another device, remove a transporter user device identifier from a list of potential transporters for future deliveries, generate a warning flag to store in association with the transporter identifier, or any other suitable process based on the classifications.

In yet other embodiments, if the task is to classify the journey as a successful delivery by an autonomous vehicle or an unsuccessful delivery by the autonomous vehicle, then further processing can include using the classification to modify the performance of the autonomous vehicle. For example, the classification of an unsuccessful delivery can be used along with the location data and other journey data to further train a machine learning model that informs the autonomous vehicle's movement.

The central server computer 102 can perform the process described in FIG. 5 for a plurality of journeys to generate a plurality of maps that are used to train the machine learning model. For example, the central server computer 102 can generate thousands or millions of maps that are used as training data to further train the machine learning model.

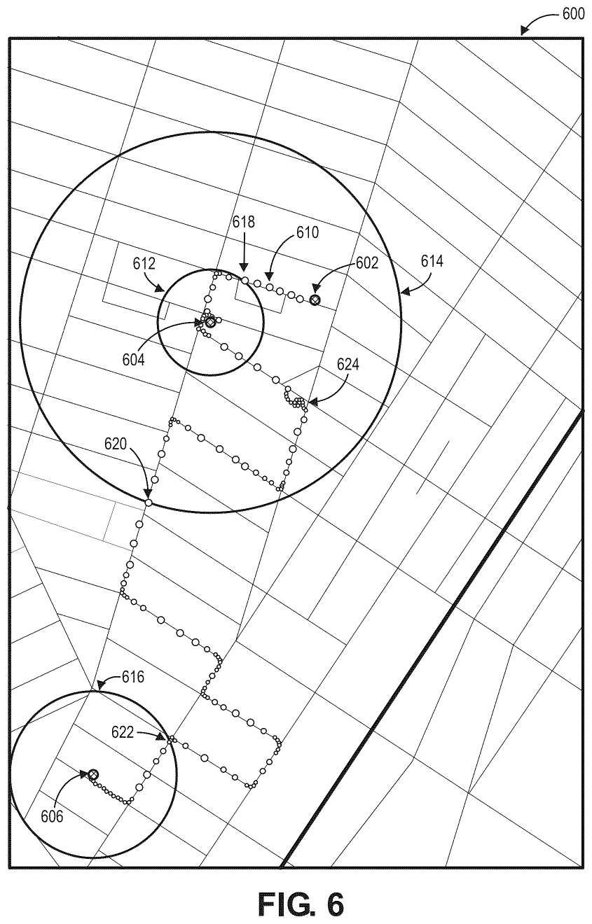

FIG. 6 shows a diagram illustrating a map that is analyzed by a machine learning model according to embodiments. FIG. 6 illustrates a map 600 depicting situation in which a transporter intentionally delayed delivering an item to an end user during a journey. A transporter may intentionally delay a journey in a situation where the transporter is compensated for the length of time taken to deliver an item to an end user.

The map 600 includes a delivery accepted location 602, a pickup location 604 and a drop-off location 606. The delivery accepted location 602 can indicate a location at which the transporter notified the central server computer 102 of a request to perform the delivery. The pickup location 604 can indicate a service provider location that provides the items for pickup and are to be provided to the end user at the drop-off location 606.

The map 600 includes location data points, such as the example location data point 610. The location data points indicate the location of the transporter over time during the journey. The size of each location data point corresponds to the speed of the transporter at that location. For example, larger circles indicate a higher speed.

The map 600 includes three geofences including an entering service provider location geofence 612, a leaving service provider location geofence 614, and an entering end user location geofence 616. Each geofence can indicate a virtual boundary at which an event occurs.

The situation illustrated in FIG. 6 can include a number of events as recorded in the delivery data. The transporter can accept the delivery at the delivery accepted location 602 at 8:11 PM.

At 8:14 PM, the transporter crosses the entering service provider location geofence 612. When the transporter crosses the entering service provider location geofence 612, an event triggers that indicates that the transporter is approaching the pick up location 604. The transporter user device can provide location data to the central server computer 102 when the transporter crosses the entering service provider location geofence 612. For example, entering service provider location location data 618 can be recorded.

At 8:22 PM, the transporter arrives at the pickup location 604.

At 8:27 PM, a service provider computer (e.g., the service provider computer 122) can provide a notification to the transporter and the central server computer 102 that the items (e.g., food) are ready for pickup. The items can be ready for pick up at 8:27 PM.

At 8:35 PM, the transporter can notify the central server computer 102 that the items are being picked up.

At 9:18 PM, the transporter crosses the leaving service provider location geofence 614. When the transporter crosses the leaving service provider location geofence 614, an event triggers that indicates that the transporter is leaving the pick up location 604 after picking up the items to be delivered. The transporter user device can provide location data and time data at the point when the transporter crosses the leaving service provider location geofence 614 to the central server computer 102. For example, after leaving service provider location, location data 620 can be recorded by the central server computer 102.

At 9:29 PM, the transporter crosses the entering end user location geofence 616. When the transporter crosses the entering end user location geofence 616, an event triggers that indicates that the transporter is approaching the drop-off location 606 with the items. The transporter user device can provide location data to the central server computer 102 when the transporter crosses the entering end user location geofence 616. For example, an entering end user location location data 622 can be recorded.

At 9:33, the transporter confirms delivery of the items to the drop-off location 606.

The machine learning model that evaluates the map can identify that there is a collection of many location data points at the location 624. The machine learning model can identify the location 624 due to the number and size of location data circles at that position on the map. The machine learning model can also identify that the location 624 is a distance away from the road that would appear to be a better path to the end user.

Due to the evaluation of the location data points at the location 624, the machine learning model can determine that the behavior of the transporter was not due to external circumstances, and can classify the journey represented in the map as being intentional delay by the transporter. For example, the transporter drove from the pickup location 604 to a parking lot at the location 624 and waited in a parking lot from 8:39 PM to 9:10 PM. This 11 minute delay can be difficult for a user to identify, but the machine learning model can be trained to identify clustering of location data points based on size and location on the map to determine this manner of causing intentional delay.

In some embodiments, the map can include a background that shows satellite imagery (not shown in FIG. 6). The machine learning model can perform object identification of objects in the satellite imagery around the location data points. The machine learning model can identify the location 624 as being a parking lot rather than a road construction zone. As such, the machine learning model can utilize object detection to aid in the determination of the classification. For example, if the location 624 was a road construction zone, then the machine learning model can classify the journey as not including intentional delay since the transporter may have been immobilized in traffic in the road construction zone.

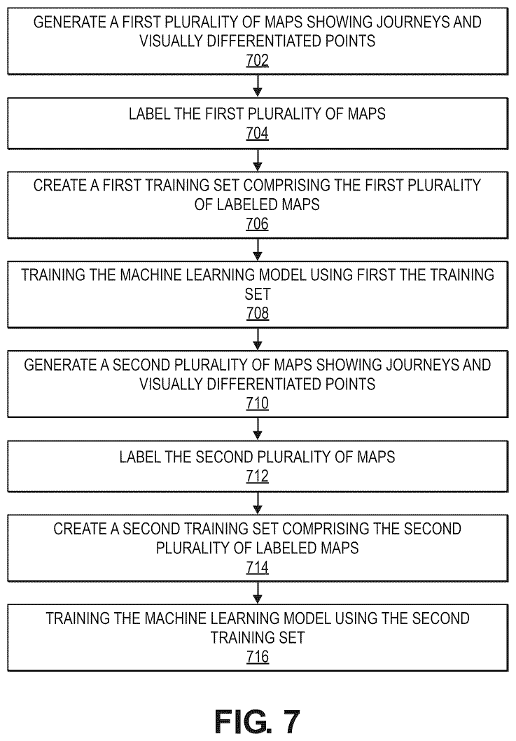

FIG. 7 shows a flow diagram of a machine learning model training method according to embodiments. The method illustrated in FIG. 7 can be performed by the central server computer 102. The central server computer 102 can train the machine learning model to classify images of maps. The machine learning model can be, for example, a convolutional neural network. The central server computer 102 can perform the method illustrated in FIG. 7 prior to the method illustrated in FIG. 6.

At step 702, during a first machine learning model training phase, the central server computer 102 can generate a first plurality of maps showing journeys and visually differentiated points.

The central server computer 102 can generate the maps of the first plurality of maps showing journeys and visually differentiated points similar to steps 502-510. For example, the central server computer 102 can obtain a journey identifier for each journey in a first plurality of journeys. The central server computer 102 can obtain location data and time data for each journey in the first plurality of journeys from a database. The central server computer 102 can determine points along each journey using the location data and time data for each journey in the first plurality of journeys. The central server computer 102 can visually differentiate the points along each journey according to a predetermined criteria. The central server computer 102 can then generate a map for each journey in the first plurality of journeys showing the journey and the visually differentiated points. The central server computer 102 can generate any number of maps (e.g., 1,000, 50,000, 1,000,000, etc. maps) for the first plurality of maps.

At step 704, the central server computer 102 can label each map of the first plurality of maps. The journeys associated with the maps in the first plurality of maps can be labeled. The label can indicate information about the journey. For example, the label can be “fraudulent” or “not fraudulent.” As another example, the label can be a numerical value in the range from 0-10 that indicates a likelihood that the journey involves some sort of fraud. Each of the journeys utilized to create the first plurality of maps may be pre-labeled.

At step 706, after labeling each map of the first plurality of maps, the central server computer 102 can create a first training set comprising the first plurality of labeled maps.

At step 708, the central server computer 102 can train the machine learning model using the first training set. The central server computer 102 can iteratively input maps from the first training set into the machine learning model to generate predictions. The central server computer 102 can compare the prediction to the label for each map. The central server computer 102 can modify weights in the machine learning model to optimize a loss function such that subsequently input maps have more accurately generated predictions.

At step 710, during a second machine learning model training phase, the central server computer 102 can generate a second plurality of maps showing journeys and visually differentiated points. The central server computer 102 can obtain additional maps to further train the machine learning model. For example, the central server computer 102 can generate 1,000, 50,000, 1,000,000, etc. maps for the second plurality of maps. The maps included in the second plurality of maps may all be uniquely different from the maps included in the first plurality of maps.

At step 712, the central server computer 102 can label each map of the second plurality of maps. The journeys associated with the maps in the second plurality of maps can be labeled. The label can indicate information about the journey. The maps of the second plurality of maps can have the same label categories or numerical values as the maps of the first plurality of maps.

At step 714, the central server computer 102 can create a second training set comprising the second plurality of labeled maps.

At step 716, after creating the second training set, the central server computer 102 can train the machine learning model using the second training set. The central server computer 102 can iteratively input maps from the second training set into the machine learning model to generate predictions. The central server computer 102 can compare the prediction to the label for each map. The central server computer 102 can modify weights in the machine learning model to optimize a loss function such that subsequently input maps have more accurately generated predictions.

The central server computer 102 can perform any number of training phases to train the machine learning model.

In some embodiments, steps 702-708 are not required and maps showing visually differentiating points and their labels (e.g., fraudulent or not fraudulent) can be used to train a machine learning model.

Embodiments of the disclosure have a number of advantages. Embodiments of the invention can be used to generate interactive maps of journeys which are intuitive and useful for users to evaluate. Such maps can then be used to train machine learning models, and those trained machine learning models can be used to classify certain behaviors or characteristics of the journeys. A central server computer need not retrieve a significant amount of raw journey data and preprocess it to adequately train machine learning models. The maps can serve dual purposes of being informative to users while also being useful to efficiently train machine learning models to recognize characteristics or behaviors of transporters, or other aspects of the journeys.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
obtaining, by a server computer, location data and time data associated with a transporter user device of a transporter that travels from a first location to a second location during a journey;
determining, by the server computer, points along the journey using the location data and the time data;
visually differentiating, by the server computer, the points along the journey according to a predetermined criteria;
creating, by the server computer, a map showing the journey and the visually differentiated points; and
inputting, by the server computer into a machine learning model, the map showing the journey and the visually differentiated points to classify the journey.

2. The method of claim 1 further comprising:
prior to obtaining the location data and the time data, obtaining, by the server computer, a journey identifier and a task identifier.

3. The method of claim 2, wherein the location data and the time data are obtained from a database using the journey identifier.

4. The method of claim 2 further comprising:
generating, by the server computer, a model request message comprising the task identifier;
providing, by the server computer, the model request message to a model database; and
receiving, by the server computer, a model response message comprising the machine learning model from the model database.

5. The method of claim 2, wherein visually differentiating the points along the journey comprises:
generating, by the server computer, a visualization preset request message comprising the task identifier;
providing, by the server computer, the visualization preset request message to a database; and
receiving, by the server computer, a visualization preset response message comprising visualization preset related to the task identifier.

6. The method of claim 5, wherein the visualization preset indicate at least one of a shape, a color, a pattern, a border, or a size for map elements in the map.

7. The method of claim 1, wherein inputting the map into the machine learning model comprises:
generating, by the server computer, an image based on the map; and
inputting, by the server computer, the image into the machine learning model.

8. The method of claim 1, wherein the predetermined criteria is a speed, a transporter vehicle type, and/or transporter index.

9. The method of claim 1 further comprising:
determining, by the server computer, an output classification from the machine learning model based on the map, wherein the output classification classifies the journey.

10. The method of claim 9, wherein the output classification is a classification of whether or not the transporter involved in the journey performed intentional delay during the journey.

11. The method of claim 9, wherein the output classification is a classification of whether or not the transporter involved in the journey actually delivered an item for the journey at a drop-off location.

12. The method of claim 1, wherein the server computer is a central server computer, the transporter is an autonomous vehicle integrated with the transporter user device, and wherein the journey is a delivery.

13. A server computer comprising:
a processor; and
a computer-readable medium coupled to the processor, the computer-readable medium comprising code executable by the processor for implementing a method comprising:
obtaining location data and time data associated with a transporter user device of a transporter that travels from a first location to a second location during a journey;
determining points along the journey using the location data and the time data;
visually differentiating the points along the journey according to a predetermined criteria;
creating a map showing the journey and the visually differentiated; and
inputting, into a machine learning model, the map showing the journey and the visually differentiated points to classify the journey.

14. The server computer of claim 13 further comprising:
a map generation module coupled to the processor;
a machine learning module coupled to the processor; and
a communication module coupled to the processor.

15. The server computer of claim 13, wherein the method further comprises:
prior to obtaining the location data and the time data, obtaining a journey identifier and a task identifier from a client device, wherein the location data and the time data are obtained from a database using the journey identifier.

16. The server computer of claim 13, wherein the method further comprises:
during a first machine learning model training phase, generating a first plurality of maps showing journeys and visually differentiated points;
labeling each map of the first plurality of maps;
creating a first training set comprising the first plurality of labeled maps;
training the machine learning model using the first training set;
during a second machine learning model training phase, generating a second plurality of maps showing journeys and visually differentiated points;
labeling each map of the second plurality of maps;
creating a second training set comprising the second plurality of labeled maps; and
training the machine learning model using the second training set.

17. The server computer of claim 13, wherein the server computer is a central server computer, and the transporter is an autonomous vehicle integrated with the transporter user device, and wherein the method further comprises:
determining an output classification from the machine learning model based on the map, wherein the output classification classifies the journey, wherein the output classification is a classification of whether or not the autonomous vehicle successfully navigated the journey.

18. A method comprising:
obtaining, by a device, a journey identifier for a journey involving a transporter user device of a transporter that travels from a first location to a second location during the journey
obtaining, by the device, a task identifier;
providing, by the device, the journey identifier and the task identifier to a central server computer, wherein the central server computer obtains location data and time data associated with the transporter user device, determines points along the journey using the location data and the time data, visually differentiates the points along the journey according to a predetermined criteria, creates a map showing the journey and the visually differentiated points, and inputs, into a machine learning model, the map showing the journey and the visually differentiated points to classify the journey to form a classification; and
receiving, by the device, the classification of the journey.

19. The method of claim 18, wherein the device is a client device, and wherein the task identifier identifies a task of determining whether or not the journey includes intentional delay by the transporter.

20. The method of claim 18, wherein the machine learning model is trained by:
generating a plurality of maps showing journeys and visually differentiated points;
labeling each map of the second plurality of maps;
creating a training set comprising the plurality of labeled maps; and
training the machine learning model using the training set.
